(19) United States
(12) Patent Application Publication
(10) Pub. No.: US 2015/0088760 A1
(43) Pub. Date: Mar. 26, 2015

(54) AUTOMATIC INJECTION OF SECURITY CONFIRMATION

(71) Applicant: Nuance Communications, Inc., Burlington, MA (US)

(72) Inventor: Pim van Meurs, Kenmore, WA (US)

(73) Assignee: NUANCE COMMUNICATIONS, INC., Burlington, MA (US)

(21) Appl. No.: 14/033,384

(22) Filed: Sep. 20, 2013

(51) Int. Cl. G06Q 20/40

(52) U.S. Cl. CPC G06Q 20/4012
USPC 705/72

(57) ABSTRACT

Technology is described to monitor incoming channels or messages for a security confirmation code, capture a received confirmation code, recognize a designated field or other destination opportunity to enter a security confirmation code, and automatically inject the captured code to the recognized destination. Various other aspects of the technology are described herein.

### BACKGROUND

Multi-factor authentication, often referred to as two-factor authentication, is an increasingly common approach to verifying identity. Perhaps the most familiar form of multi-factor authentication is a facility that requires, in addition to information that the user knows, e.g., a password or PIN code, proof that the user has possession of a personal item, e.g., a mobile phone or smart card. For example, banking at an automated teller machine (“ATM”) requires the user to have both a physical ATM card and a secret personal identification number (“PIN”). Only with both required identifying factors can someone use an ATM to access the user's bank account. Thus, multi-factor authentication makes it more difficult for another to impersonate the user.

In the context of online access to secured computing facilities such as a virtual private network (“VPN”) or banking website, the required factors typically include a secret password known to the user and a security code provided to the user via an electronic device in the user's possession. The security code may be, e.g., a pseudorandom number from a hardware security token or software application on a mobile device; or an alphanumeric confirmation code (a one-time password) sent to the user's mobile phone by a short message service (“SMS”) text message or automated telephone call. To log in to the desired service or website, the user must enter both the user's own password and the received one-time-use confirmation code.

Such a confirmation code is an example of “out-of-band” authentication: the code is sent over a different network or communication channel than the first avenue for authentication (e.g., a cell phone number via the phone's cellular network, as well as a secure Web session in a browser via the Internet). Out-of-band authentication helps to ensure that the user is who he or she claims to be, by requiring the user to control the end points of each channel. For example, it would be difficult for an adversary to pose as the user to gain access to a website that uses out-of-band authentication if the adversary does not have the user's mobile phone or other second channel end point.

### BRIEF DESCRIPTION OF THE DRAWINGS

FIG. 1 is a block diagram showing some of the components typically incorporated in at least some of the computer systems and other devices on which the technology is implemented.

FIG. 2 is a system diagram illustrating an example of a computing environment 200 in which the technology may be utilized.

FIG. 3A is a display diagram showing an example of login elements indicating use of a security confirmation code.

FIG. 3B is a display diagram showing an example of login elements with a field for a confirmation code.

FIG. 4 is a display diagram illustrating graphical user interfaces that allow a user to receive a confirmation code on a mobile device.

FIGS. 5A-5E are flow diagrams showing steps typically performed by the technology to recognize, deliver, and inject a confirmation code.

FIG. 6 is a sequence diagram illustrating messages sent in accordance with various implementations of the technology to automatically inject a confirmation code.

### DETAILED DESCRIPTION

### Overview

The inventor has recognized that conventional approaches to two-factor authentication have significant disadvantages. For instance, for the user to confirm his or her identity using a confirmation code sent via SMS typically requires the user to check the user's received text messages, open the correct message, identify the code, remember the number, and type it in to the appropriate field in a browser session. This process is inconvenient and potentially error-prone.

Technology is described to monitor incoming channels for a confirmation code (e.g., in an SMS or email message), capture a received confirmation code, and automatically insert the information into an appropriate field (e.g., in a Web browser).

In some implementations, the technology is incorporated into an input method editor (“IME”) that runs whenever a text field is active. Examples of IMEs include, e.g., a Swype® or FlexT9® text entry interface in a mobile computing device. An IME typically is not a user application, but instead is integrated with or part of an operating system (“OS”), e.g., as part of the Android® OS on devices such as tablets and mobile phones. In some implementations, the technology is a non-IME component of an operating system.

In some implementations, the technology is context-aware and thus can recognize when the active user application is a Web browser or other relevant application (e.g., a banking application). In some implementations, the technology can detect the context of a Website that requires two-factor authentication and/or detect when a field—or the active field—is a field for entering a password or confirmation code. Such context awareness may be accomplished, e.g., by URL recognition (for example, identifying a known bank's Web address, or recognizing a Web page or elements within a page transmitted via a secure protocol such as https) and/or field name or type parsing (for example, a text field labeled “password” or “confirmation_code”, or an HTML Document Object Model (“DOM”) password object). To identify and correctly parse a Web site, the technology can query a back-end knowledgebase for known templates or use locally stored (cached) information.

In some implementations, the technology (e.g., within an IME that does not have OS-level privileges) is not context-aware, and the technology includes a browser plugin, script (e.g., JavaScript®), scriptlet or applet (e.g., Java®), Web proxy, Website, or Web browser. A script, application, or rendering engine that can inject JavaScript into a page can obtain access to the DOM that reveals the structure of a Web page including, e.g., field names and types. In some implementations, the technology is aware of the context of the currently active field (e.g., a field selected for user input), and automatically injects a received confirmation code into the appropriate field when it is active.

The technology identifies and captures a confirmation code sent to a device implementing the technology, via an SMS message to a mobile device or another channel. In some implementations, the technology uses the source of the incoming message to determine whether the message is likely to contain a confirmation code. For example, a text message from a telephone number or a short code known to belong to a financial institution is highly likely to contain a confirmation code. Such a source may be identified with, e.g., a set or range of numbers from which the user or other users has received a confirmation code in the past. In some implementations, identifying the source may include reference to a knowledgebase that is at least partly crowdsourced, e.g., with examples of sources of confirmation codes, which might include secure SMS senders or email addresses associated with a temporary replacement password for a Web site. In some implementations, the technology identifies a source of a confirmation code as associated with a Web site where the user has been prompted to enter a confirmation code, and uses the identified association to route the correct code to the user's browser. The technology may consider an unknown sender to be a more likely source of a confirmation code than a contact present in the user's list of contacts or address book. The technology may recognize a confirmation code forwarded, e.g., from a family member. The technology can learn from user behavior, e.g., corrections, user answers to questions posed by the system, etc. The technology can also identify the date and time that the message was sent or received, to determine whether it corresponds with the date and time that a confirmation code may be required.

In parsing a candidate message, the technology may look for a series of digits, a non-word alphanumeric string, or a message containing only one word or string. In some implementations, the technology identifies text with a low probability of being a word associated with the user's language model or dictionary corpus. In some implementations, the technology uses templates to identify characteristics of confirmation codes, e.g., types of codes associated with the sender or associated with a Website visited by the user. Such characteristics may include accompanying text, e.g., surrounding brackets (“[ . . . ]”) or a phrase such as “Your code is: . . . ” or “Temporary password: . . . .” In some implementations, the technology employs a knowledgebase stored locally or remotely for use in recognizing confirmation codes. In some implementations, such a knowledgebase is at least partly crowdsourced, e.g., with examples of received confirmation codes being added to the knowledgebase (or being added if the user accepts the confirmation code chosen by the technology, and being removed or not added if the user deletes or changes the confirmation code chosen by the technology). In some implementations, the technology includes a learning component that asks a user (possibly at the user's initiation) to identify a confirmation code, and that uses the user's identification to improve future recognition of confirmation codes.

A security confirmation code may not be textual. In some implementations, the technology identifies a confirmation code from audio input, e.g., by transcription from a telephone call using speech voice recognition. In some implementations, such transcription is performed by a remote computing device, e.g., a set of servers with more computing power than a handheld device. For example, a confirmation code may be sent via a voice channel to a phone. The user can forward the message to a voice mail service or a voice processing component of the technology that transcribes the message. The technology can then (optionally encrypt and) forward the transcribed confirmation code to the user's registered devices. In some implementations, the technology identifies a confirmation code from a picture file, e.g., by image recognition to convert a graphic image to text. In some implementations, the technology parses a request for authenticating information, e.g., a notification requesting a ZIP code for credit card purchase verification or fraud alert notification, and uses stored information about the user to automatically populate a response. In some implementations, the technology opens a dialog or otherwise gives the user an option of whether to send the proposed response to the destination (and to ask the user to verify or identify the proper code if needed).

In some implementations, the technology operates in multiple modes or channels in a single device. For example, the technology may, as described above, capture information about input fields in a Web browser session running on a device that also receives email or SMS messages. When the technology detects a field for entering a confirmation code or a page that is known to generate a confirmation code, and intercepts an incoming message that contains a confirmation code, the technology captures the confirmation code from the incoming message and inserts it into the detected field for entering the received code. In some implementations, the receipt of a message containing a confirmation code triggers the technology to identify a potential field for entering the code. In some implementations, the technology may direct the browser to a page for entering the received code and populate a field in the destination page with the received code, or store the received code until the user navigates to the code entry page and then populate the desired field.

In some implementations, the technology operates on more than one device. For example, the technology may run on a desktop computer or set-top box where the user wishes to log in to a secured Web site, and simultaneously on a mobile phone where the user can receive phone calls or text messages. Because both devices are networked, the technology can communicate across devices, e.g., with a remote server component of the technology with which both devices are registered (identifying both devices as belonging to the same user). Establishing communications with a remote server may include activating an inactive communications channel or accessing an active communications channel. Devices may also be directly peer networked or connected by various forms of near-field communication (“NFC”), especially when both devices are operated by the same user and thus in close proximity. In some implementations, the technology detects the user's presence at both devices, e.g., by the user's active status in an instant messaging (“IM”) service or application. By direct or indirect networking between devices, the technology can detect an opportunity to insert a confirmation code on one computing device and the receipt of the necessary code on another device, transmit the received code from one device to the other, and then automatically enter it in the appropriate location.

To improve security, the technology may require a secured channel between endpoints (e.g., an encrypted link for transmitting a confirmation code from the user's phone to a server and from the server to the user's computing device), or may secure the transmitted confirmation code, e.g., by applying a digital signature (encrypting and authenticating the transmission). A component of the technology may require authentication of the end user, e.g., by voice recognition, before operation. For example, with a voice call, the technology may use voice recognition to help verify the identity of the person with possession of the user's telephone, e.g., comparing the person's voice with a voice signature database. In some implementations, the technology requires the user's voice authentication to decrypt a confirmation code.

In some implementations, the technology ensures that different devices are located near one another (and thus probably not stolen) by using only NFC technologies or other local networking technologies such as Bluetooth®, by verifying that the devices are using the same Wi-Fi network, and/or by checking that location services (e.g., using GPS or cell tower data) report the devices in the same or nearly the same location. If devices appear not to be in the same location, the technology escalates an authentication challenge to ensure that both devices (and thus both communication channel endpoints) are in the control of the authorized user.

In some implementations, the technology simplifies authentication in contexts other than Web logins. For example, in conjunction with a smart television or set-top box and a mobile phone or other personal computing device, the technology can ease verification that a user has the right to order a movie by passing a confirmation code or other credential from one device to the other. Because the connection between devices is symmetric, information can flow both ways. For example, if an application (e.g., an authentication challenge from a TV or a Web purchase) requests that the user respond to the challenge—e.g., by calling a phone number, visiting a Web page, or texting a confirmation string to a specified destination—the technology can send the destination address or phone number to the user's phone along with the required message content so that the user can transmit the required confirmation without having to type anything. In some implementations, the technology allows a user to automatically respond to such a challenge by sending the required information from the user's mobile phone. For voice calls where a user is required to speak a confirmation code, the technology can include speech synthesis or the ability to play recorded audio files.

In some implementations, the technology allows two-factor authentication in contexts where such authentication previously would have been cumbersome. For example, biometrically controlled access such as a fingerprint or retinal scan (requiring proof of who the user is) can be paired with a code delivered to a user-controlled device (requiring proof of what the user has) with greater convenience when the technology can seamlessly transmit the delivered code to the authenticating system. For another example, the technology allows a mobile device to serve as an anti-theft safeguard for a networked computer, television, or car. The mobile device might even also serve as a Wi-Fi or cellular network tethering device, e.g., allowing a movie to be downloaded from the Internet to be watched on a screen in a car upon verification of the user's order by confirmation code sent via a cellular network. Whether the confirmation code channel is voice, data, text, or another mode or medium, the technology enables convenient confirmation between end point devices controlled by the user.

### DESCRIPTION OF FIGURES

The following description provides certain specific details of the illustrated examples. One skilled in the relevant art will understand, however, that the technology may be practiced without many of these details. Likewise, one skilled in the relevant art will also understand that the technology may include many other obvious features not described in detail herein. Additionally, some well-known structures or functions may not be shown or described in detail below, to avoid unnecessarily obscuring the relevant descriptions of the various examples.

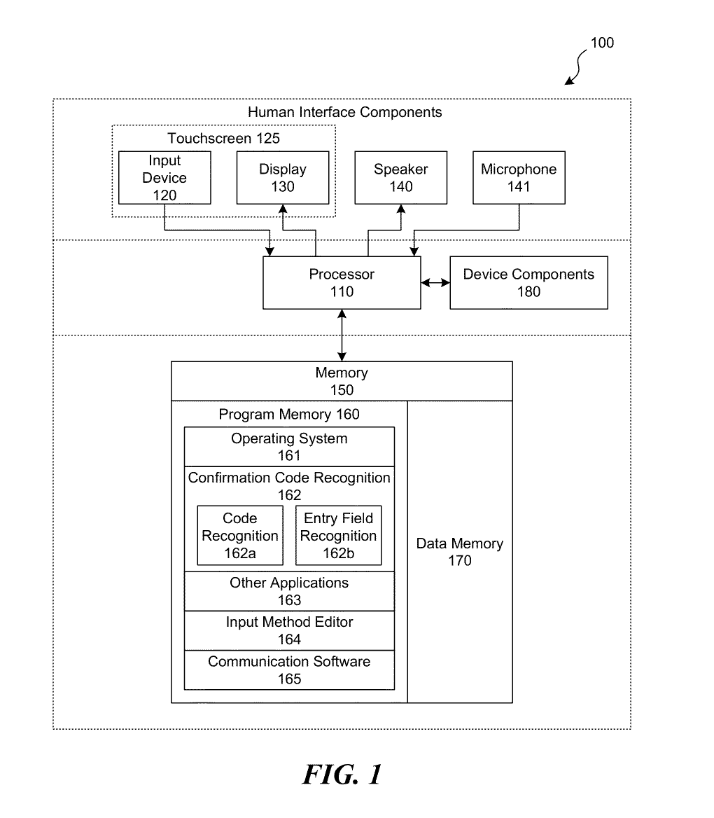

FIG. 1 is a block diagram showing some of the components typically incorporated in at least some of the computer systems and other devices on which the technology is implemented. A system 100 includes one or more input devices 120 that provide input to a processor 110, notifying it of actions performed by a user, typically mediated by a hardware controller that interprets the raw signals received from the input device and communicates the information to the processor 110 using a known communication protocol. The processor may be a single CPU or multiple processing units in a device or distributed across multiple devices. Examples of an input device 120 include a keyboard, a pointing device (such as a mouse, joystick, or eye tracking device), and a touchscreen 125 that provides input to the processor 110 notifying it of contact events when the touchscreen is touched by a user. Similarly, the processor 110 communicates with a hardware controller for a display 130 on which text and graphics are displayed. Examples of a display 130 include an LCD or LED display screen (such as a desktop computer screen or television screen), an e-ink display, a projected display (such as a heads-up display device), and a touchscreen 125 display that provides graphical and textual visual feedback to a user. Optionally, a speaker 140 is also coupled to the processor so that any appropriate auditory signals can be passed on to the user as guidance, and a microphone 141 is also coupled to the processor so that any spoken input can be received from the user, e.g., for systems implementing speech recognition as a method of input by the user. In some implementations, the speaker 140 and the microphone 141 are implemented by a combined audio input-output device. The system 100 may also include various device components 180 such as sensors (e.g., GPS or other location determination sensors, motion sensors, and light sensors), cameras and other video capture devices, communication devices (e.g., wired or wireless data ports, near field communication modules, radios, antennas), and so on.

The processor 110 has access to a memory 150, which may include a combination of temporary and/or permanent storage, and both read-only memory (ROM) and writable memory (e.g., random access memory or RAM), writable non-volatile memory such as flash memory, hard drives, removable media, magnetically or optically readable discs, nanotechnology memory, biological memory, and so forth. As used herein, memory does not include a propagating signal per se. The memory 150 includes program memory 160 that contains all programs and software, such as an operating system 161, confirmation code recognition software 162, and any other application programs 163. The confirmation code recognition software 162 includes components such as a code recognition portion 162a, for identifying a security confirmation code, and an entry field recognition portion 162b, for identifying a destination for a security confirmation code. The program memory 160 may also contain input method editor software 164 for managing user input according to the disclosed technology, and communication software 165 for transmitting and receiving data by various channels and protocols. The memory 150 also includes data memory 170 that includes any configuration data, settings, user options and preferences that may be needed by the program memory 160 or any element of the device 100.

FIG. 1 and the discussion herein provide a brief, general description of a suitable computing environment in which the technology can be implemented. Although not required, aspects of the system are described in the general context of computer-executable instructions, such as routines executed by a general-purpose computer, e.g., a mobile device, a server computer, or a personal computer. Those skilled in the relevant art will appreciate that the technology can be practiced using other communications, data processing, or computer system configurations, e.g., hand-held devices (including tablet computers, personal digital assistants (PDAs), and mobile phones), multi-processor systems, microprocessor-based consumer electronics, set-top boxes, network appliances, mini-computers, mainframe computers, etc. The terms “computer,” “host,” and “device” are generally used interchangeably herein, and refer to any such data processing devices and systems.

Aspects of the technology can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a local area network (LAN), wide area network (WAN), or the Internet. In a distributed computing environment, modules may be located in both local and remote memory storage devices.

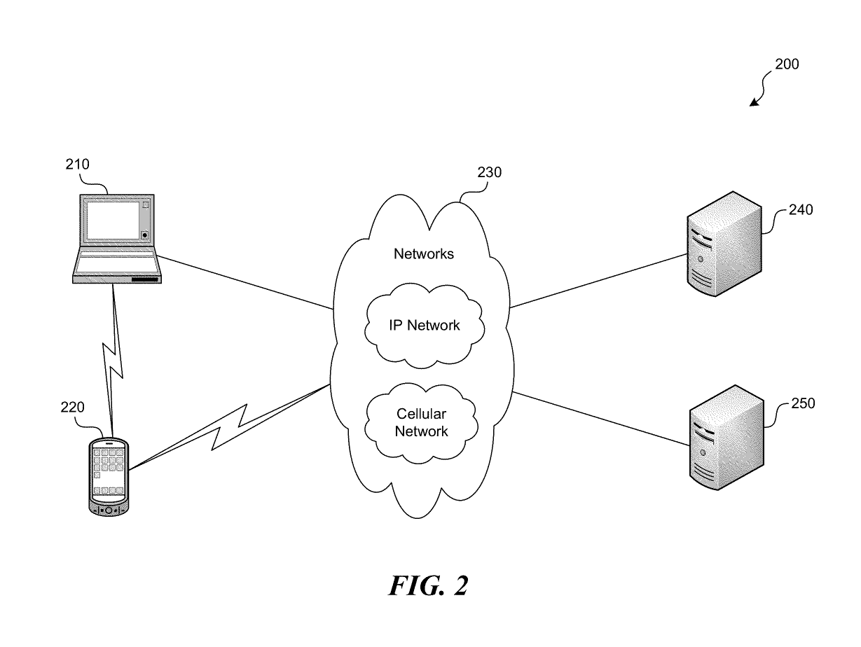

FIG. 2 is a system diagram illustrating an example of a computing environment 200 in which the technology may be utilized. As illustrated in FIG. 2, a system for automatic capture and injection of security confirmation may operate on various computing devices, such as a computer 210, mobile device 220 (e.g., a mobile phone, tablet computer, mobile media device, mobile gaming device, wearable computer, etc.), other devices capable of receiving user inputs (e.g., such as set-top box or vehicle-based computer). Each of these devices can include various input mechanisms (e.g., microphones, keypads, and/or touch screens) to receive user interactions (e.g., voice, text, gesture, and/or handwriting inputs). These computing devices can communicate through one or more wired or wireless, public or private, networks 230 (including, e.g., different networks, channels, and protocols) with each other and with a system 240 implementing the technology, as well as with a server 250 that generates or transmits messages containing a security confirmation code, or that requests a security confirmation code. As described herein, user events (e.g., selection of a field for entering a security confirmation code) may be communicated to the system 240. In addition, information about the user or the user's device(s) (e.g., the location of the device(s)) may be communicated to the system 240. In some implementations, some or all of the system 240 is implemented in user computing devices such as devices 210 and 220.

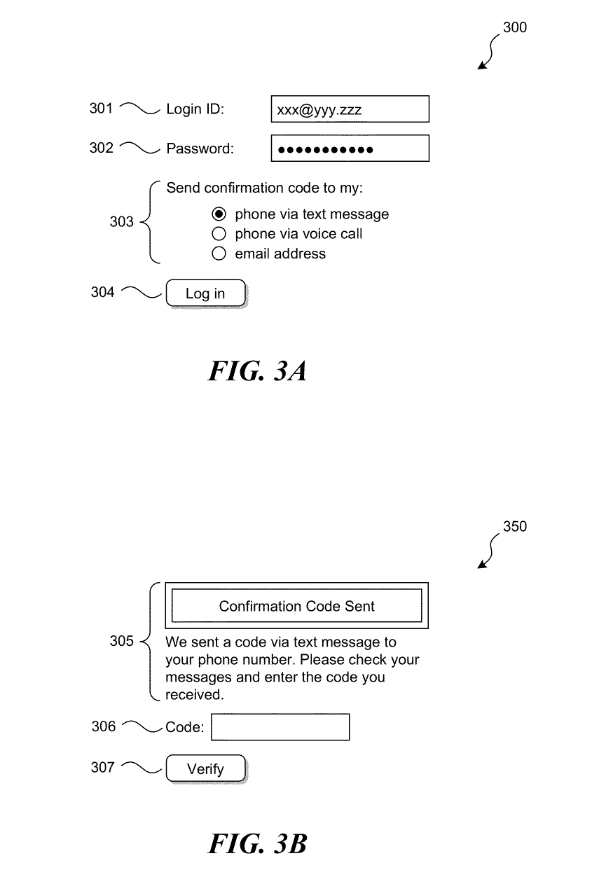

FIG. 3A is a display diagram showing an example of login elements 300 indicating use of a security confirmation code. User login identification field 301 allows a user to identify himself or herself to a facility or resource such as a VPN or banking website. In addition to the identity information provided in the login ID field 301, the user is prompted to enter a password 302. The login page shows by a message and selection control 303 that if the user's identification and password are recognized by the facility or resource when the user submits them using the “Log in” button 304, it will proceed to send a security confirmation code to the user via text message, telephone call, or email address. In some implementations of the technology, such a login page is recognized as a page that causes a confirmation code to be sent to the user.

FIG. 3B is a display diagram showing an example of login elements 350 with a field for a confirmation code. Confirmation code sent message 305 alerts the user that a security confirmation code has been sent to the user (in the illustrated case, via a SMS text message). Once the code has been received, it can be entered into the provided confirmation code entry field 306, which then allows the user to proceed using “Verify” button 307 to confirm the user's identity through a multi-factor authentication process. In various implementations, the technology recognizes the code entry field 306 (or the login elements 350 as a whole), captures the confirmation code sent to the user, and enters the confirmation code in the code entry field 306 for the user. In some implementations, the technology activates the button 307 to finish the security confirmation code verification process.

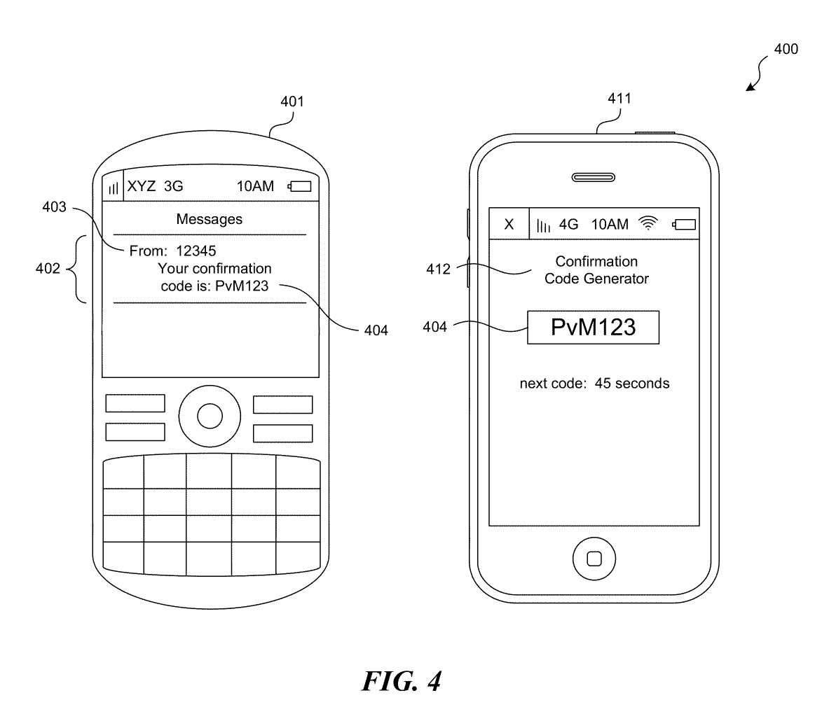

FIG. 4 is a display diagram illustrating graphical user interfaces that allow a user to receive a confirmation code on a mobile device. In one example device 401, a screen shows an incoming message 402. The message 402 includes data identifying the sender 403 (in the illustrated case, a short code 12345; other senders could include, e.g., an email address, a telephone number, or an identified contact). The message 402 contains a confirmation code 404, and may contain additional information about the code or how to use it (e.g., a hyperlink). In various implementations, the technology captures a code received in a message sent to the user. In another example device 411, a confirmation code generator app 412 displays a code 404, such as a rotating code that changes after a period of time. In some implementations, the technology captures a code generated by a code generator app compatible with the technology, or upon user selection or copying of a generated code.

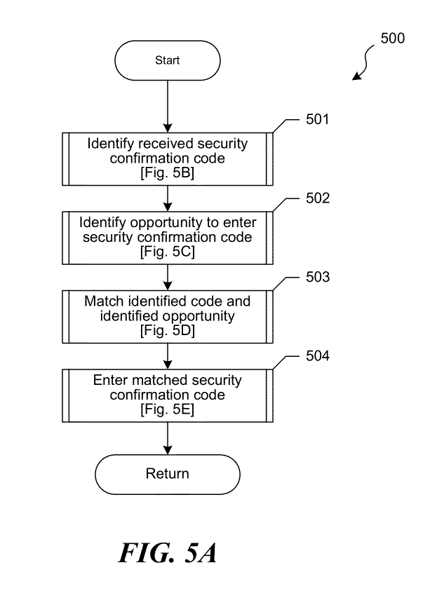

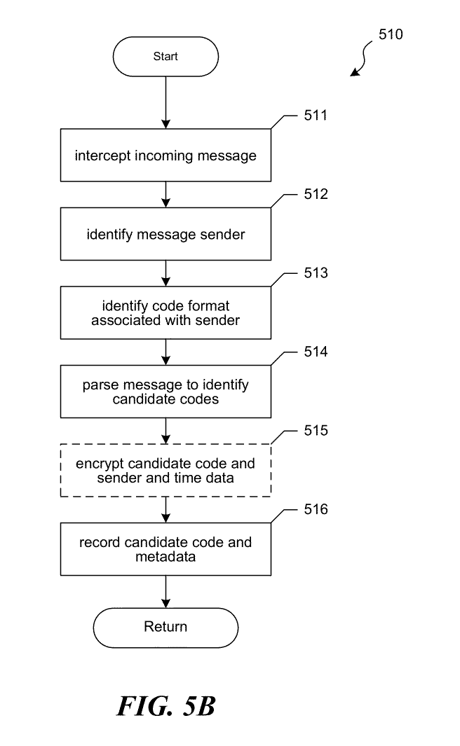

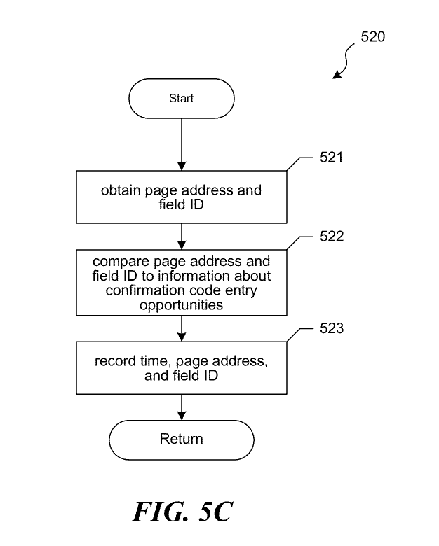

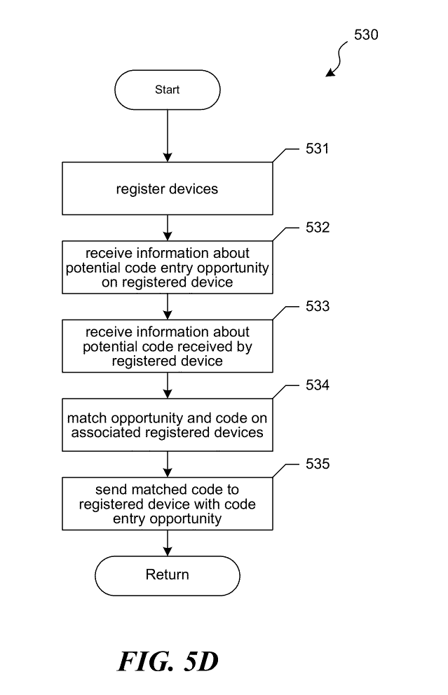

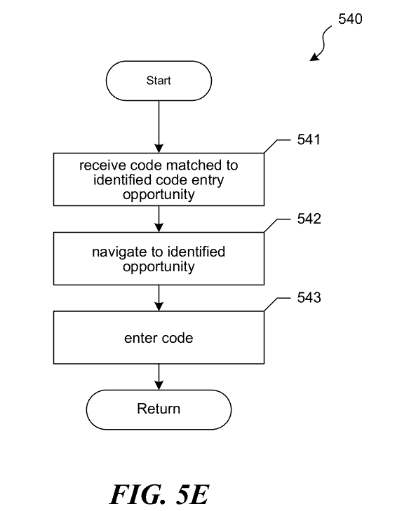

FIGS. 5A-5D are flow diagrams showing steps typically performed by the technology in some implementations to recognize, deliver, and inject a confirmation code. FIG. 5A is a flow diagram 500 showing a broad outline of the steps performed in capturing a security confirmation code, matching the code with a destination, and entering the code in the appropriate destination. In step 501, the technology identifies a received security confirmation code, e.g., in a message sent to the user or to one of the user's devices. Step 501 is discussed in greater detail below in connection with FIG. 5B. In step 502, the technology identifies an opportunity to enter a security confirmation code, e.g., in a Web page on a user device. Step 502 is discussed in greater detail below in connection with FIG. 5C. In step 503, the technology matches the identified security confirmation code and the identified opportunity to enter a security confirmation code. Step 503 is discussed in greater detail below in connection with FIG. 5D. In step 504, the technology enters the matched security confirmation code for the user. Step 504 is discussed in greater detail below in connection with FIG. 5E.

FIG. 5B is a flow diagram 510 showing steps typically performed by the technology in some implementations (in connection with step 501 in FIG. 5A) to identify a received security confirmation code. In step 511, the technology intercepts an incoming message sent to the user or to a device controlled by the user. In some implementations, the technology captures or filters every message sent to a user address or device, or is configured to receives copies of messages sent to the user over various channels, e.g., email, text messages, or voice messages. In step 512, the technology identifies the sender of the intercepted message. In some implementations, the technology compares the sender identification data to a knowledgebase of senders that have sent security confirmation codes to the user or to other users of the technology. In step 513, the technology identifies a format of a security confirmation code associated with the identified sender. Codes sent from a particular source may be identifiable by a common form, e.g., an alphanumeric string of a particular length or range of lengths preceded by a phrase like “your code is:” or accompanied by instructions or a URL.

In step 514, the technology parses the intercepted message to identify a candidate security confirmation code. Various aspects of such parsing are discussed in greater detail above (e.g., identifying text with a low probability of being a correctly spelled word in the user's language model as a probable confirmation code candidate, or using a known confirmation code message format to isolate a probable confirmation code candidate). In some cases, a message may contain more than one candidate code, e.g., if a message provides multiple codes and instructs the user to enter the third code. In some implementations, the technology parses the instructions to identify one code (e.g., associating the text “third” with the third code in the message). In step 515, the technology optionally encrypts the identified candidate security confirmation code or codes together with information about the sender and when the message containing the code was sent or received, and in step 516 the technology records the candidate code and the metadata describing its receipt and other contextual information about the code. In some implementations, the technology securely transmits the candidate security confirmation code for delivery to the code's destination.

FIG. 5C is a flow diagram 520 showing steps typically performed by the technology in some implementations (in connection with step 502 in FIG. 5A) to identify an opportunity to enter a security confirmation code. In step 521, the technology obtains information that can be used to identify a destination for a security confirmation code, such as a web page address and field name or ID. In some implementations, the technology determines the URL of a Web page and parses the page's DOM or text to locate a field designated for entry of a security confirmation code. In some implementations, the technology receives information about a text entry field selected by a user. In step 522, the technology compares the obtained information to data characterizing confirmation code entry opportunities. For example, the technology may compare a URL and field name or ID against a database of URLs and field names or IDs that are recognized as security confirmation code entry opportunities, and the technology may compare indicia such as text presented to the user in connection with a field (e.g., “Enter code here:”) to characteristics associated with security confirmation code entry opportunities to determine a probability that an object or element is a security confirmation code entry opportunity. In step 523, the technology records information about the identified opportunity, including, e.g., the details of the opportunity and the time that the opportunity was identified.

FIG. 5D is a flow diagram 530 showing steps typically performed by the technology in some implementations (in connection with step 503 in FIG. 5A) to match an identified security confirmation code and an identified opportunity to enter a security confirmation code. In step 531, the technology associates devices, channels, or addresses with a user or with each other, e.g., by registering devices to a user account or profile. In some implementations, registration is implicit, e.g., where the technology operates within a single device for one user. In step 532, the technology receives information about a potential code entry opportunity on a registered device, e.g., information saved as described in connection with FIG. 5C step 523. In step 533, the technology receives information about a potential security confirmation code received at a registered device or address, e.g., information saved as described in connection with FIG. 5B step 516. In some implementations, the technology operates across more than one device and transmits information relating to a code or a code entry opportunity between devices. In some implementations, the transmitted information includes an identifier for association with a registered device or account. In step 534, the technology matches information about a code and a code entry opportunity on associated registered devices. For example, the technology may compare the address of a code entry opportunity with the source of a message containing a confirmation code and verify that they correspond. Alternatively or additionally, the technology may verify that the times when the code and the opportunity were obtained also correspond within a certain time frame. In step 535, the technology delivers the recorded security confirmation code to a component of the technology associated with the matching code entry opportunity, e.g., transmitting the code (and any information necessary to authenticate the code and specify its destination). For example, the technology may securely transmit a received code from a registered mobile device where the code was received or from a server where the code was matched with a code entry opportunity to a computing device where the user—or the technology—can enter the code.

FIG. 5E is a flow diagram 540 showing steps typically performed by the technology in some implementations (in connection with step 504 in FIG. 5A) to enter a security confirmation code for the user. In step 541, the technology receives a code matched to an identified code entry opportunity, e.g., together with information identifying the opportunity to which the code is matched. In some implementations, the code is received securely, e.g., over a secure communication channel or via an authenticated and encrypted data transmission. In step 542, the technology optionally navigates to the identified code entry opportunity. For example, the technology may bring an application in which a code may be entered to the foreground; navigate a browser to a page for entering a security confirmation code (e.g., a URL link sent to the user by a confirmation code sender); or highlight or bring focus to a field in which a confirmation code may be entered. In some implementations, the technology prompts a user for input, e.g., to approve the entry of a captured confirmation code or to obtain permission to navigate to an identified code entry opportunity. In step 543, the technology enters the code in the identified destination.

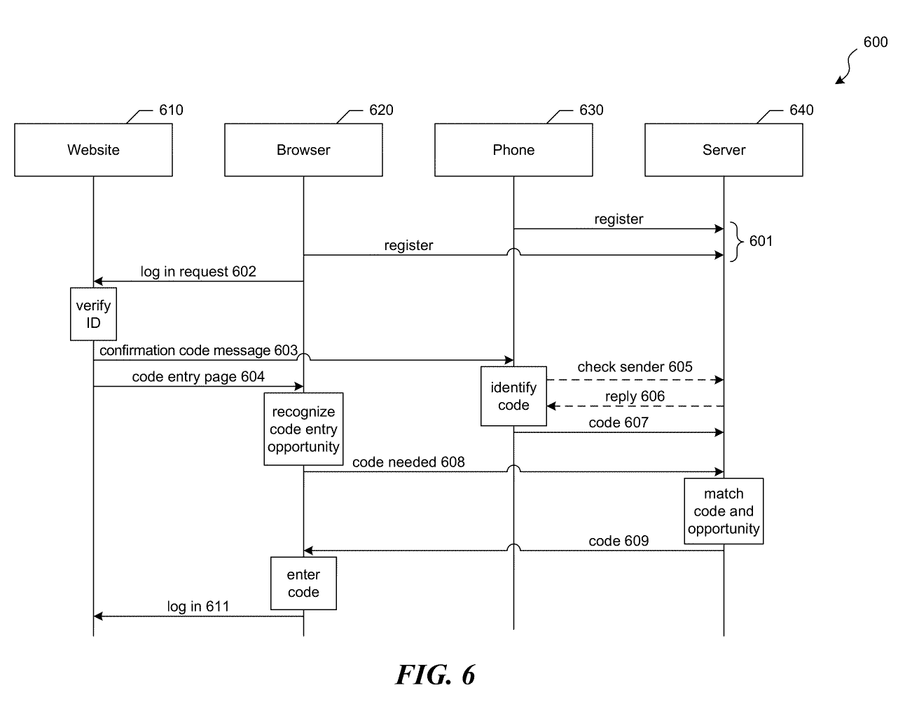

FIG. 6 is a sequence diagram illustrating messages sent in accordance with various implementations of the technology to automatically inject a confirmation code. The illustrated example shows communication between a website 610, a browser 620, a mobile phone 630, and a server 640 in accordance with some implementations of the technology. In some implementations of the technology, some or all of the browser 620, phone 630, and server 640 operate within a single device; in other implementations, components of the technology operate across various and additional devices. In step 601, the browser 620 and phone 630 register with server 640 such that code entry opportunities identified in one may be associated with codes identified in another. The browser 620 sends a log in request 602 requesting access to a secure resource of the website 610. After verifying an identification credential (e.g., a login username) to associate the login request 602 with a user who owns or controls the phone 630, the website 610 sends a confirmation code message 603 to the phone 630. The website also responds to the log in request 602 by sending a code entry page 604 back to the browser 620.

The phone 630 receives the confirmation code message 603 and the technology intercepts the message 603 and identifies the code contained in it. In some implementations, code identification is performed by the server 640. As illustrated, the phone 630 optionally sends a message 605 to the server 640 to check the sender (e.g., to determine whether the sender is recognized as sending confirmation codes and if so, to obtain formats of confirmation codes associated with the sender) and receives a reply 606 from the server 640. After isolating the code from the confirmation code message 603, the phone 630 sends the code 607 to the server 640. Meanwhile, the browser 620 receives the code entry page 604 from the website 610, and the technology recognizes a code entry opportunity in the received code entry page 604. In some implementations, the browser 620 communicates with the server 640 in the process of identifying the code entry opportunity. The browser 620 sends a message to the server 640 indicating that a code is needed for the recognized opportunity. In some implementations, recognition of a code entry opportunity (or that a code is needed) is performed by the server 640. The server matches the identified code and the recognized code entry opportunity and sends the code 609 to the browser 620. The browser 620 receives the code 609, enters it into the code entry page 604 and proceeds to log in 611, providing automated completion of the multi-factor login process.

In some cases, the components may be arranged differently than are indicated above. Single components disclosed herein may be implemented as multiple components, or some functions indicated to be performed by a certain component of the system may be performed by another component of the system. In some aspects. software components may be implemented on hardware components. Furthermore, different components may be combined. In various implementations, components on the same machine may communicate between different threads, or on the same thread, via inter-process communication or intra-process communication, including in some cases such as by marshalling the communications across one process to another (including from one machine to another), and so on.

The above examples are not intended to be exhaustive or to limit the technology to the precise form disclosed above. While specific examples are described above for illustrative purposes, various equivalents and modifications are possible within the scope of the disclosure, as those skilled in the relevant art will recognize. For example, while steps or blocks are presented in a given order, alternative implementations may perform routines or arrange systems in a different order, and some steps or blocks may be deleted, moved, added, subdivided, combined, and/or modified to provide alternative combinations or subcombinations. Each of these steps or blocks may be implemented in a variety of different ways. Also, while processes are at times shown as being performed in series, they may instead be performed or implemented in parallel, or may be performed at different times. Further, any specific numbers noted herein are only examples: alternative implementations may employ differing values or ranges.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, aspects may be embodied as a means-plus-function claim under 35 U.S.C §112(f), or in other forms, such as being embodied in a computer-readable memory. (Any claims intended to be treated under 35 U.S.C. §112(f) will begin with the words “means for”, but use of the term “for” in any other context is not intended to invoke treatment under 35 U.S.C. §112(f).) Accordingly, the applicant reserves the right to pursue additional claims after filing this application to pursue such additional claim forms, in either this application or in a continuing application.

I claim:

1. A system in an electronic device for capturing a security confirmation code from a first communication channel and injecting the security confirmation code into a second communication channel, comprising:
at least one processor;
a monitoring component in the electronic device configured to automatically identify a message from the first communication channel that contains a security confirmation code;
an extraction component in the electronic device configured to automatically capture the security confirmation code from the identified message;
a destination component in the electronic device configured to automatically identify a field designated for user input of a security confirmation code into a second communication channel;
a data structure for associating the captured security confirmation code with the identified field designated for user input of a security confirmation code; and
an injection component in the electronic device configured to automatically insert the captured security confirmation code into the associated identified field.

2. The system of claim 1 wherein:
at least one of the monitoring component, the extraction component, the destination component, or the injection component is part of an input method editor; and
all of the components are on a mobile device.

3. The system of claim 1 wherein:
the destination component comprises a script, a plugin, a browser, an operating system, or a Web proxy;
all of the components are on a mobile device;
the first communication channel comprises an SMS text message, an email message, or a mobile device notification alert; and
the second communication channel comprises a Web page.

4. The system of claim 1, further comprising:
an encryption component configured to encrypt the captured security confirmation code; and
a decryption component configured to decrypt the encrypted security confirmation code.

5. The system of claim 1, further comprising:
a learning component that prompts a user to identify a security confirmation code; and wherein:
the learning component uses a user's identification of a first security confirmation code to improve recognition of a second security confirmation code at a later time.

6. A system for capturing a security confirmation code from a first communication channel in a first electronic device and injecting the security confirmation code into a second communication channel in a second electronic device, comprising:
a monitoring component in the first device configured to identify a message from the first communication channel that contains a security confirmation code;
an extraction component in the first device configured to capture the security confirmation code from the identified message;
a first device communication component configured to transmit the captured security confirmation code;
a second device communication component configured to receive the captured security confirmation code;
a destination component in the second device configured to identify a field designated for user input of the security confirmation code into a second communication channel; and
an injection component in the second device configured to insert the captured security confirmation code into the identified field.

7. The system of claim 6 wherein the first device communication component is configured to communicate directly with the second device communication component.

8. The system of claim 6, further comprising a third electronic device, and wherein:
the first device communication component and the second device communication component are each configured to communicate with the third electronic device;
the first device is a mobile phone;
the second device is a computer having a Web browser; and
the third device is a remote server.

9. The system of claim 6, further comprising an encryption component in the first device configured to encrypt the captured security confirmation code or require a secure transmission channel to be established before transmitting the captured security confirmation code.

10. The system of claim 6, further comprising:
a location check component configured to verify that the first device and the second device are near one another before the first device transmits the captured security confirmation code; and wherein:
verification that the first device and the second device are near one another comprises determining that location services on the devices report substantially similar coordinates or that both devices are connected to the same local wireless network.

11. The system of claim 6, further comprising:
a location check component configured to verify that the first device and the second device are near one another before the first device transmits the captured security confirmation code; and
an authentication challenge component configured to prompt the user to confirm that both the first device and the second device are under control of the user when location of a device is not verified.

12. A computer-readable memory having contents configured to cause at least one computer having a processor to perform a method for capturing a security confirmation code from a first communication channel and injecting the security confirmation code via a second communication channel, the method comprising:
identifying, by the processor, a message that contains a security confirmation code in a first communication channel;
extracting the security confirmation code from the identified message;
identifying a field designated for user input of the security confirmation code into a second communication channel; and
injecting the captured security confirmation code into the identified field, such that the captured security confirmation code is conveyed from the first communication channel to the second communication channel.

13. The computer-readable memory of claim 12 wherein:
identifying a message that contains a security confirmation code comprises:
identifying the source of the message; and
determining whether the source of the message is known to send security confirmation codes, is associated with a financial institution, is associated with the source of the identified field designated for user input of the security confirmation code, or is associated with a user address book contact; and wherein:
extracting the security confirmation code from the identified message comprises:
using a template to identify characteristics of confirmation codes associated with the sender or associated with the source of the identified field designated for user input of the security confirmation code.

14. The computer-readable memory of claim 12 wherein identifying a message that contains a security confirmation code comprises:
identifying a first date and time that the message was sent or received;
identifying a second date and time associated with availability of a field designated for user input of a security confirmation code; and
determining whether the first date and time is substantially similar to the second date and time.

15. The computer-readable memory of claim 12 wherein extracting the security confirmation code from the identified message comprises identifying text with a low probability of being a word associated with the user's language model or dictionary corpus.

16. The computer-readable memory of claim 12 wherein extracting the security confirmation code from the identified message comprises speech recognition of a telephone voice call or recording.

17. The computer-readable memory of claim 12 wherein identifying a field designated for user input of the security confirmation code comprises identifying a Web page protocol, domain name, host name, field type, or field name.

18. The computer-readable memory of claim 12, further comprising, before injecting the captured security confirmation code into the identified field, prompting the user to confirm sending the captured security confirmation code.

19. The computer-readable memory of claim 12 wherein injecting the captured security confirmation code into the identified field comprises inserting the captured code when the user selects or activates the identified field.

20. The computer-readable memory of claim 12, further comprising directing a browser to a page for entering the captured code.
